(19) United States
(12) Patent Application Publication
(10) Pub. No.: US 2025/0196824 A1
(43) Pub. Date: Jun. 19, 2025

(54) METHOD FOR DISTRIBUTING A BRAKING LOAD, AND BRAKING DEVICE

(71) Applicant: Robert Bosch GmbH, Stuttgart (DE)

(72) Inventors: Nikolas Loeffelmann, Dielheim (DE); Christian Schleinig, Stuttgart (DE); Herbert Vollert, Vaihingen/Enz (DE)

(21) Appl. No.: 18/847,703

(22) PCT Filed: Apr. 5, 2023
(86) PCT No.: PCT/EP2023/058945

§ 371 Date: Sep. 17, 2024

(30) Foreign Application Priority Data
Apr. 13, 2022 (DE) 10 2022 203 752.9

(51) Int. Cl. B60T 8/1755; B60T 8/171; B60T 8/172

(52) U.S. Cl. CPC B60T 8/17551; B60T 8/171; B60T 8/172

(57) ABSTRACT

A method for distributing braking load. The method includes building up an initial first braking pressure in order to set a braking power by means of a first braking apparatus; and building up a second braking pressure by activating a second braking apparatus when a predetermined condition occurs, and simultaneously reducing the first braking pressure such that the braking power remains substantially unchanged.

### FIELD

The present invention relates to a method for distributing a braking load and to an associated method.

### BACKGROUND INFORMATION

Methods for motor vehicles that allow pressure to be maintained in the wheel brake cylinders at various automation levels are described in the related art.

On the one hand, a driver can keep the vehicle stationary and, if necessary, on an incline by keeping the pedal permanently pressed, for example.

On the other hand, there are so-called holding functions, which usually run as a value-added function on an electronic stability program. These are activated autonomously or by the driver and thus allow the vehicle to be held braked when stationary using hydraulic pressure. The benefit is mainly an increase in comfort when stopping briefly on an incline.

If pressure is maintained only via the electronic stability program, changeover valves are used for this purpose. If the pressure is maintained by means of a brake booster, the pressure build-up capability of the brake booster is used, which is activated by the electronic stability program via the volume flow interface. The brake booster also maintains pressure when the pedal is operated.

Due to pressure being maintained for a long time, the changeover valves in the electronic stability program or the electric motor in the brake booster, depending on the configuration, must be continuously energized. This can lead to a thermal overload of the device in question or to a restriction of functionality in the event of a deliberate shutdown.

German Patent Application No. DE 10 2006 042 930 A1 describes a an example of a conventional braking device having multiple braking apparatuses.

### SUMMARY

With the present invention, thermal overload of a braking device can be advantageously avoided.

According to the present invention, a method for distributing a braking load and a braking device are provided.

Accordingly, a method for distributing a braking load is provided. According to an example embodiment of the present invention, initially, a first braking pressure is built up by means of a first braking apparatus in order to set a braking power. When a predetermined condition occurs, a second braking pressure is built up by activating a second braking apparatus, while at the same time the first braking pressure is reduced such that the braking power remains substantially unchanged.

Furthermore, a braking device is provided. The braking device comprises a first braking apparatus and a second braking apparatus. The first braking apparatus is designed to build up an initial first braking pressure in order to set a braking power. The second braking apparatus is designed to build up a second braking pressure. The first braking apparatus is further designed, when the second braking apparatus is activated, to reduce the first braking pressure such that the braking power remains substantially unchanged.

One concept of the present invention lies in the distribution of the pressure load between two braking apparatuses during holding maneuvers when the vehicle is stationary. The heat output occurring in the respective braking apparatuses can advantageously be kept low thereby, thus avoiding thermal overload.

Advantageous embodiments and developments of the present invention are disclosed herein.

According to a preferred example embodiment of the present invention, the first braking apparatus and the second braking apparatus comprise a combination of at least one brake booster and an electronic stability program. In this case, the first braking apparatus can comprise a brake booster, and the second braking apparatus can comprise an electronic stability program, and vice versa. The use of these braking apparatuses, which are provided as standard in many vehicles, allows an advantageously simple implementation of the present invention.

According to a preferred example embodiment of the present invention, the predetermined condition comprises a predetermined time elapsing after the initial first braking pressure has been built up, a predetermined temperature of the first braking apparatus being reached, or a manual input by a user. Activating the second braking apparatus after a predetermined time has elapsed is advantageously easy to implement technically. Activating the second braking apparatus when a predetermined temperature of the first braking apparatus is reached is particularly suitable for preventing thermal overload. Activating the second braking apparatus by manual input allows a user to have an advantageously greater degree of control over the method.

According to a preferred example embodiment of the present invention, the method is carried out only under certain conditions, in particular at a standstill or when the engine is running. This can advantageously prevent the braking load from occurring in situations where this is not desired.

According to a preferred example embodiment of the present invention, the braking device comprises a controller that is designed to control the function of the first braking apparatus and the second braking apparatus. This controller can also be designed as a component of the first braking apparatus or of the second braking apparatus. This allows the control of the braking device to be advantageously customized to the braking device to be controlled.

The present invention is explained in more detail below based upon the exemplary embodiments shown in the schematic figures.

### BRIEF DESCRIPTION OF THE DRAWINGS

FIG. 1 is a schematic flow diagram of a method for distributing a braking load according to an exemplary embodiment of the present invention.

FIG. 2 is a schematic representation of a braking device according to an exemplary embodiment of the present invention.

FIG. 3 is a schematic representation of a braking device according to a further exemplary embodiment of the present invention.

FIG. 4 is a time graph of the curves of first braking pressure, second braking pressure, braking power and temperature of a first braking apparatus in an exemplary embodiment of the present invention.

### DETAILED DESCRIPTION OF EXAMPLE EMBODIMENTS

The accompanying figures are intended to impart further understanding of the embodiments of the present invention. They illustrate embodiments and, in connection with the description, serve to explain principles and concepts of the present invention. Other embodiments and many of the mentioned advantages are apparent from the drawings. The elements of the drawings are not necessarily shown to scale relative to one another.

In the figures, identical, functionally identical and identically acting elements, features and components are provided with the same reference signs in each case, unless otherwise stated.

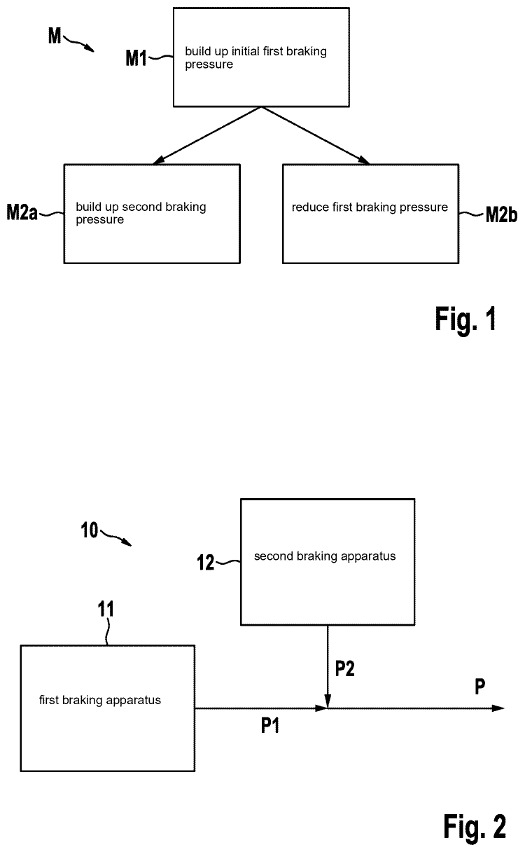

FIG. 1 shows a schematic flow diagram of a method M for distributing a braking load according to an exemplary embodiment of the present invention.

In a first method step M1, an initial first braking pressure is built up by means of a first braking apparatus in order to set a braking power. In a method step M2a, a second braking pressure is built up by activating a second braking apparatus when a predetermined condition occurs, wherein, in a simultaneous method step M2b, the first braking pressure is reduced such that the braking power remains substantially unchanged.

The method shown here is explained in more detail in the following figures using braking devices according to exemplary embodiments of the present invention.

FIG. 2 shows a schematic representation of a braking device 10 according to an exemplary embodiment of the present invention.

The braking device 10 comprises a first braking apparatus 11 and a second braking apparatus 12. The first braking apparatus 11 is designed to initially build up a first braking pressure P1 in order to set a braking power P. The second braking apparatus 12 is designed to build up a second braking pressure P2. The first braking apparatus 11 is further designed to reduce the first braking pressure P1 at the same time as building up the second braking pressure P2 such that the braking power P remains substantially unchanged.

In the following, an exemplary embodiment is explained in more detail, in which the first braking apparatus 11 comprises a brake booster, and the second braking apparatus 12 comprises an electronic stability program. However, this exemplary embodiment is for explanatory purposes only and is not intended to limit the subject matter of the present invention.

First, a first braking pressure is initially built up in a master brake cylinder by means of the brake booster, which corresponds to the first method step M1 in FIG. 1.

For example, if the vehicle is at a standstill, and the pressures in the master brake cylinder and wheel brake cylinder are approximately static, further method steps of a method according to the present invention can be carried out. The method can then be carried out in a time-controlled or temperature-controlled manner, on the basis of another sensor input such as a manual operation, or randomly.

The electronic stability program can use changeover valves to create a pressure difference between wheel pressure and master brake cylinder pressure. For example, the changeover valves can be closed, which corresponds to method step M2a in FIG. 1. At the same time, the brake booster reduces its boosting force, which corresponds to method step M2b in FIG. 1. Due to the high stiffness between the master brake cylinder and changeover valves, the pressure drops suddenly. Due to the reduced back pressure, less power is required in the brake booster, which allows a saturation of the temperature to be achieved before a critical temperature threshold is exceeded.

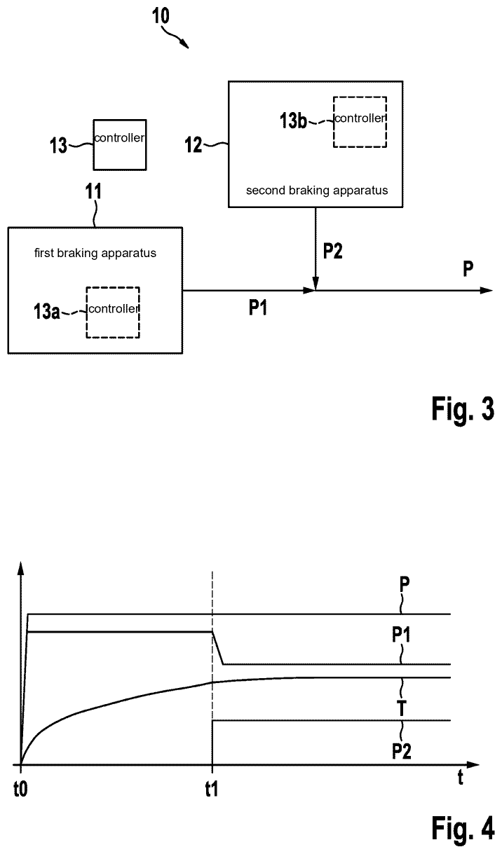

FIG. 3 shows a schematic representation of a braking device 10 according to a further exemplary embodiment of the present invention.

In addition to the features shown in FIG. 2, the braking device 10 additionally comprises a controller 13 that is designed to control the function of the first braking apparatus 11 and the second braking apparatus 12.

The controller 13 can be designed, among other things, to control the first braking apparatus 11 and the second braking apparatus 12 only under certain conditions, in particular at a standstill or when the engine is running.

The controller 13 can be an independent component, as shown here with solid lines. However, the controller 13a, 13b can alternatively also be designed as a component of the first braking apparatus 11 or of the second braking apparatus 12, as shown here with dashed lines.

If the controller 13a is arranged in the first braking apparatus 11, the actuator position known internally in a brake booster can be used as a predetermined condition, for instance.

If the controller 13b is arranged in the second braking apparatus 12, a pressure measured in an electronic stability program can be used as a predetermined condition, for instance.

It is also possible for multiple controllers to be provided, either as independent components or components of the braking apparatuses 11, 12, which communicate with each other in order to control the individual components of the braking device.

FIG. 4 shows a time graph of the curves of first braking pressure, second braking pressure, braking power and temperature of a first braking apparatus in an exemplary embodiment of the present invention.

At an initial time point to, a brake signal is triggered, whereupon an initial first braking pressure P1 is built up by means of a first braking apparatus. This directly results in a braking power P to be achieved. It can also be seen that a temperature T in the first braking apparatus increases over time. When a predetermined condition occurs at time point t1, a second braking apparatus is activated, whereby a second braking pressure P2 is built up. At the same time point, the first braking pressure P1 is reduced. However, the braking power P to be achieved does not change. By reducing the first braking pressure P1, the rise in temperature T in the first braking apparatus is also flattened, whereby thermal overload of the first braking apparatus can be avoided.

In the present invention, multiple features have been designated “first” and “second.” These designations serve only to clearly distinguish the individual features. In particular, no spatial or functional arrangement or prioritization is intended to be derived therefrom.

In the present application, “substantially unchanged” is to be understood as meaning that the corresponding value either remains absolutely unchanged or changes only so slightly that no functional difference is discernible.

When a list of alternatives in the present application is marked with the designation “or,” this is to be understood as meaning the listed alternatives taken individually but also, if appropriate, a combination of multiple or all of the listed alternatives.

1-10. (canceled)

11. A method for distributing braking load, the method comprising the following steps:
building up an initial first braking pressure to set a braking power using a first braking apparatus; and
building up a second braking pressure by activating a second braking apparatus when a predetermined condition occurs, and simultaneously with the building up of the second braking pressure, reducing the first braking pressure such that the braking power remains substantially unchanged.

12. The method according to claim 11, wherein the first braking apparatus and the second braking apparatus include a combination of at least one brake booster and an electronic stability program.

13. The method according to claim 11, wherein the predetermined condition includes a predetermined time elapsing after the initial first braking pressure has been built up, or a predetermined temperature of the first braking apparatus being reached, or a manual input by a user.

14. The method according to claim 11, wherein the method is carried out only under certain conditions including at a standstill or when an engine is running.

15. A braking device, comprising:
a first braking apparatus configured to build up an initial first braking pressure to set a braking power; and
a second braking apparatus configured to build up a second braking pressure;
wherein the first braking apparatus is further configured to, when the second braking apparatus is activated, reduce the first braking pressure such that the braking power remains substantially unchanged.

16. The braking device according to claim 15, wherein the first braking apparatus and the second braking apparatus include a combination of at least one brake booster and an electronic stability program.

17. The braking device according to claim 15, wherein a predetermined condition for reducing the first braking pressure and building up the second braking pressure includes a predetermined time elapsing after the initial first braking pressure has been built up, or a predetermined temperature of the first braking apparatus being reached, or a manual input by a user.

18. The braking device according to claim 15, further comprising:
a controller configured to control a function of the first braking apparatus and the second braking apparatus.

19. The braking device according to claim 18, wherein the controller is a component of the first braking apparatus or of the second braking apparatus.

20. The braking device according to claim 18, wherein the controller is configured to control the first braking apparatus and the second braking apparatus only under certain conditions, including at a standstill or when an engine is running.
